(19) United States
(12) Patent Application Publication
(10) Pub. No.: US 2026/0281261 A1
(43) Pub. Date: Sep. 17, 2026

(54) STORAGE MEDIUM STORING APPLICATION PROGRAM THAT PERFORMS POSITION SETTING OF IMAGE FORMING AREA ON PRINTING MEDIUM, CONTROL METHOD, AND INFORMATION PROCESSING APPARATUS

(71) Applicant: CANON KABUSHIKI KAISHA, Tokyo (JP)

(72) Inventor: YUKIYASU IWASAKI, Tokyo (JP)

(21) Appl. No.: 19/561,869

(22) Filed: Mar. 10, 2026

(30) Foreign Application Priority Data
Mar. 14, 2025 (JP) 2025-041420

(51) Int. Cl. H04N 1/00; G06F 3/04845; G06F 3/04855

(52) U.S. Cl. CPC H04N 1/0044; G06F 3/04845; G06F 3/04855; H04N 1/00411

(57) ABSTRACT

A non-transitory computer-readable storage medium storing an application program supporting a standard driver that is provided from a provider of an operating system. When printing is performed by an image forming apparatus capable of printing an image on a printing medium, a reception screen is displayed for receiving a position setting on a positional relationship between edges of the printing medium and an image forming area in which the image is formed by the printing on the printing medium, from a plurality of options.

### BACKGROUND

### Field of the Technology

The present disclosure relates to a storage medium storing an application program that performs position setting of an image forming area on a printing medium, a control method, and an information processing apparatus.

### Description of the Related Art

As a printing industry standard protocol, the Internet Printing Protocol (IPP) is used. Further, a printer driver (hereinafter referred to as the “local printer driver”) that directly communicates with an image forming apparatus, such as a printing apparatus, using the IPP is widely used. The local printer driver is a printer driver that is provided by a vendor (manufacturer) which provides an operating system (OS) and generates print data which can be interpreted by printers of a plurality of printer vendors. A user can transmit print data to an image forming apparatus by using the local printer driver incorporated in an information processing apparatus, such as a personal computer, without installing a printer driver specific to a printer vendor. Further, printing using a cloud print service is used. In the cloud print service, a printer driver for the cloud print service (hereinafter referred to as the “cloud printer driver”) is installed into an information processing apparatus. The cloud printer driver is a printer driver that communicates with an image forming apparatus using the IPP via the cloud print service. Further, similar to the local printer driver, the cloud printer driver is also a printer driver that is provided by a vendor which provides an OS and generates print data which can be interpreted by printers of a plurality of vendors. The user can transmit print data to an image forming apparatus via the cloud print service by using the cloud printer driver incorporated in the information processing apparatus.

The local printer driver and the cloud printer driver each handle print jobs to be printed by various types of printers regardless of a printer vendor. Therefore, in the local printer driver and the cloud printer driver, there is restriction on printing items and functions, which can be set as print settings, i.e., the local printer driver and the cloud printer driver can execute only printing items and functions, which can be commonly set for the various types of printers. To cope with this, it can be presumed that a printing item and a function, which cannot be executed by the local printer driver and the cloud printer driver, are extended. Japanese Patent Laid-Open No. 2024-30352 discloses a configuration that displays, according to a type of a printer selected as a transmission destination of print data, a print settings screen for making print settings compatible with the selected printer. For example, in a case where a printer can perform borderless printing, if this printer is an inkjet-type printer, a setting of borderless printing is displayed on the print settings screen, and if this printer is an electrophotographic printer, a setting of “print by extending the printing area” is displayed on the print settings screen.

In the borderless printing, the printing area of an image with respect to a printing medium, such as a print sheet, is generated in a size larger than the size of this printing medium (sheet size), and the image is printed such that the image extends off edges of the printing medium. This makes it possible to obtain a printed matter having no margin, referred to as a border, at the edges of the printing medium. In this borderless printing, as the extending amount of the image from the edges of the printing medium is made larger, it is easier to generate a printed matter without a border, but part of the image, which is not printed, i.e. image missing is generated by an amount corresponding to image extension. Further, on the other hand, as the image extension amount is made smaller, image missing can be reduced more, but a border is liable to be formed at the edges of the printing medium. Therefore, in the borderless printing, it is preferable to reduce generation of a border while reducing image missing as much as possible. However, in the configuration described in Japanese Laid-Open Patent Publication (Kokai) No. 2024-30352, although it is possible to switch on/off of the borderless printing, it is difficult to sufficiently cope with reduction of generation of a border while reducing image missing as much as possible.

### SUMMARY

The present disclosure is directed to providing a storage medium storing an application program that is capable of performing position setting on a positional relationship between edges of a printing medium and an image forming area on the printing medium in which an image is formed, even in a case where a standard driver is used, a control method, and an information processing apparatus.

In a first aspect of the present disclosure, there is provided a non-transitory computer-readable storage medium storing an application program supporting a standard driver that is provided from a provider of an operating system, the application program causing a computer to execute a control method including displaying, when printing is performed by an image forming apparatus capable of printing an image on a printing medium, a reception screen for receiving a position setting on a positional relationship between edges of the printing medium and an image forming area in which the image is formed by the printing on the printing medium, from a plurality of options.

In a second aspect of the present disclosure, there is provided a control method of performing control to support a standard driver that is provided from a provider of an operating system, including displaying, when printing is performed by an image forming apparatus capable of printing an image on a printing medium, a reception screen for receiving a position setting on a positional relationship between edges of the printing medium and an image forming area in which the image is formed by the printing on the printing medium, from a plurality of options.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing a hardware configuration of a printing system according to a first embodiment.

FIGS. 2A and 2B are block diagrams each showing a software configuration of the printing system.

FIG. 3 is a diagram showing an example of a response acquired by print data generation software by issuing a Get-Printer-Attributes operation of the IPP to a printing apparatus.

FIG. 4 is a diagram showing an example of print function information generated by the print data generation software.

FIG. 5 is a diagram showing an example of print function information in which an extension amount-setting function is extended.

FIG. 6 is a diagram showing another example of the print function information in which the extension amount-setting function is extended.

FIGS. 7A and 7B are diagrams each showing an example of a print settings screen displayed on a display section of the printing system by a print settings screen-extending unit.

FIG. 8A and 8B are flowcharts of processes executed by an extension application.

FIGS. 9A to 9H are diagrams each showing a print result obtained according to a setting of an extension amount or a margin amount.

FIGS. 10A and 10B are diagrams each showing an example of print data transmitted from the extension application according to a second embodiment to a printing apparatus.

FIGS. 11A and 11B are diagrams each showing an example of a print settings screen displayed on the display section of the printing system by the print settings screen-extending unit according to a third embodiment.

### DESCRIPTION OF THE EMBODIMENTS

The present disclosure will now be described in detail below with reference to the accompanying drawings showing embodiments thereof. Configurations described in the following embodiments rare given only by way of example, and are by no means intended to limit the scope of the present disclosure. For example, components of the configurations of the present disclosure can be replaced with desired components which can exhibit the same functions. Further, desired components can be added. Further, two or more desired components (features) of the embodiments can be combined.

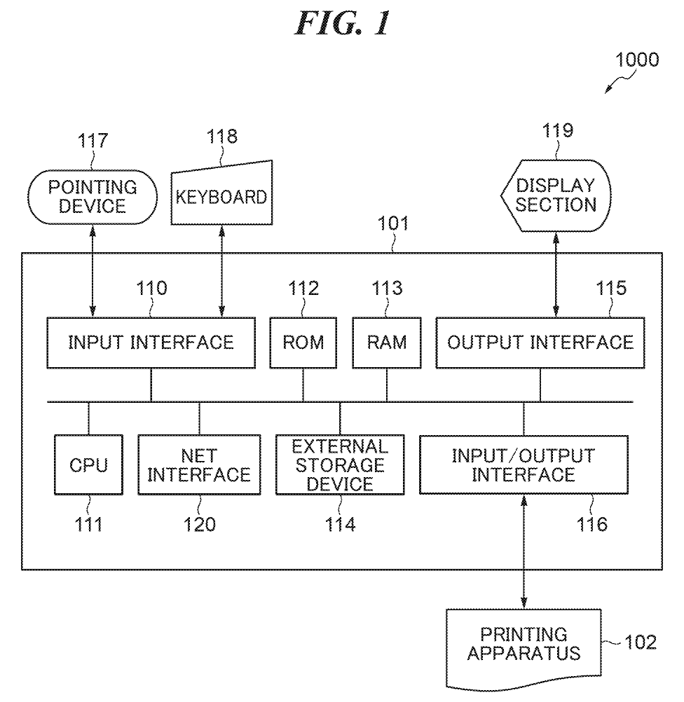

A first embodiment will be described below with reference to FIGS. 1 to 9H.

FIG. 1 is a block diagram showing a hardware configuration of a printing system according to the first embodiment. As shown in FIG. 1, the printing system, denoted by reference numeral 1000, includes a host computer 101, a printing apparatus 102, a pointing device 117, a keyboard 118, and a display section 119, and these are communicably connected to each other. The host computer 101 is an information processing apparatus and includes an input interface 110, a central processing unit (CPU) 111, a read only memory (ROM) 112, a random access memory (RAM) 113, an external storage device (storage medium) 114, an output interface 115, an input/output interface 116, and a network (NET) interface 120. Note that although, as the host computer 101, for example, a desktop-type personal computer can be used, this is not limitative, but, for example, any of a laptop-type personal computer, a tablet terminal, and a smartphone can be used.

The CPU 111 is a computer that executes e.g. programs stored in the ROM 112 or the external storage device 114. With this, the CPU 111 is capable of executing processing steps (control method), described hereinafter. In the ROM 112, an initialization program is stored. In the external storage device 114, an application program group, an OS, print data generation software, and a variety of other data items are stored. Note that in the present embodiment, as the OS, Windows (registered trademark) 11 of Microsoft (registered trademark) has been installed in the host computer 101. The RAM 113 is used e.g. as a work memory when a variety of programs stored in the external storage device 114 are executed, and the variety of programs can operate in the host computer 101. To the input interface 110, the pointing device 117 and the keyboard 118 as input devices are connected. To the output interface 115, the display section 119 as a display device is connected. On the display section 119, for example, a print settings screen (reception screen) 701A and a print settings screen (reception screen) 701B, described hereinafter, are displayed. The NET interface 120 performs control to transfer data to and from an external apparatus via a network. To the input/output interface 116, the printing apparatus 102 is connected. This enables the host computer 101 to communicate with the printing appratuses102 of a plurality of makers, i.e. process information between the host computer 101 and the printing apparatuses 102 of the plurality of makers, regardless of the maker of the printing apparatus 102.

As the printing apparatus 102, for example, an image forming apparatus, such as a multi-function peripheral (MFP) having a plurality of functions, such as copy, print, and FAX functions, can be used, but this is not limitative. Further, printing performed by the printing apparatus 102 is assumed to be printing by an inkjet method in the present embodiment but is not limited to this, and, for example, can be printing by an electrophotographic method or the like. Further, the type of the printing apparatus 102 is assumed to be a locally connected inkjet printer in the present embodiment. Local connection refers to a state of connection in which the host computer 101 and the printing apparatus 102 are connected in a state capable of directly communicating with each other via the input/output interface 116 and the NET interface 120. Cloud connection refers to a state of connection in which printing can be instructed from the host computer 101 to the printing apparatus 102 via the NET interface 120 and a cloud print service (not shown) on the Internet. Further, hereafter, description of an example of features or options is related to the locally connected inkjet printer, unless particularly specified. Further, although in the present embodiment, the host computer 101 and the printing apparatus 102 are configured as the apparatuses separate from each other, this is not limitative. For example, the host computer 101 and the printing apparatus 102 can be configured as an integrated apparatus.

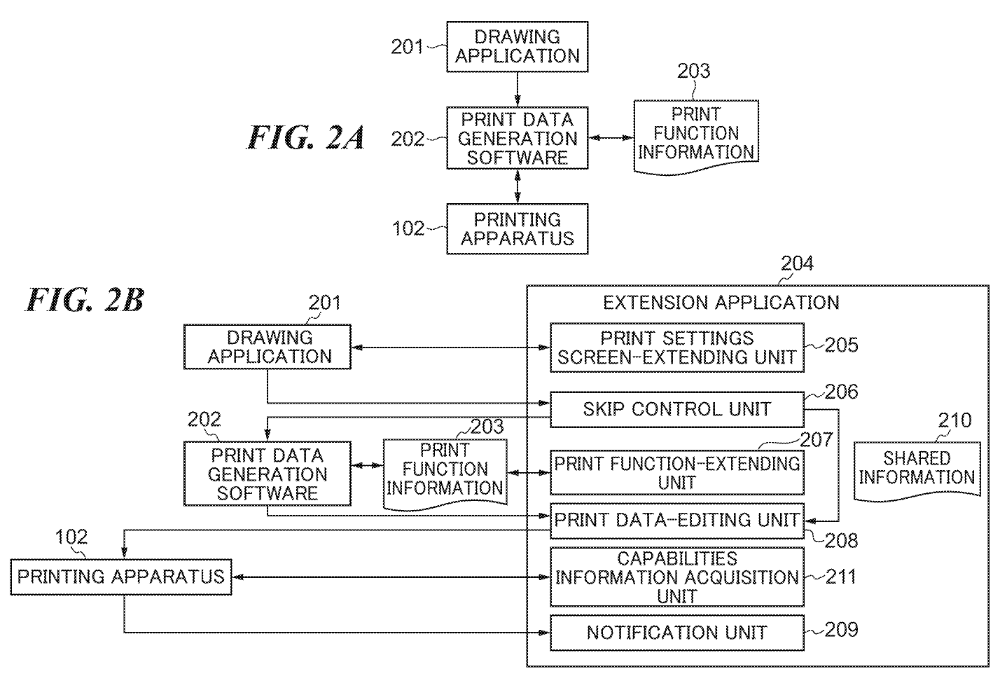

FIGS. 2A and 2B are block diagrams each showing a software configuration of the printing system 1000. FIG. 2A is a diagram showing a general configuration in a case where an extension application (application program) 204 is not associated with print data generation software (standard driver) 202 and the printing apparatus 102. FIG. 2B is a diagram showing a configuration in a case where the extension application 204 is associated with the print data generation software 202 and the printing apparatus 102. The print data generation software 202 is a standard driver provided by the provider of the OS. The standard driver is a class driver (general-purpose program) which can be commonly used for the printing apparatuses 102 of a plurality of makers, for example, when printing is performed. The standard driver is installed (incorporated) in the OS in advance, i.e. provided as one of functions in the OS package. The standard driver is capable of performing processing operations for a variety of printing apparatuses by using a standardized printing method. With this, the standard driver can generate and output an instruction which can be interpreted by the printing apparatuses of the plurality of makers. As the print data generation software 202, a program operating based on the IPP is used. The extension application 204 is a program supporting i.e. assisting the print data generation software 202. In the present embodiment, the extension application 204 is an extension program (application program for executing a control method) capable of extending functions incapable of being executed by the print data generation software 202, such that the functions can be extended, for the printing apparatus 102, but is not limited to this. For example, the extension application 204 can be a program which improves the convenience of functions which can be executed by the print data generation software 202 for the printing apparatus 102. The extension application 204 is stored in the external storage device 114 together with the OS (the print data generation software 202). Thus, the host computer 101 has the print data generation software 202 and the extension application 204.

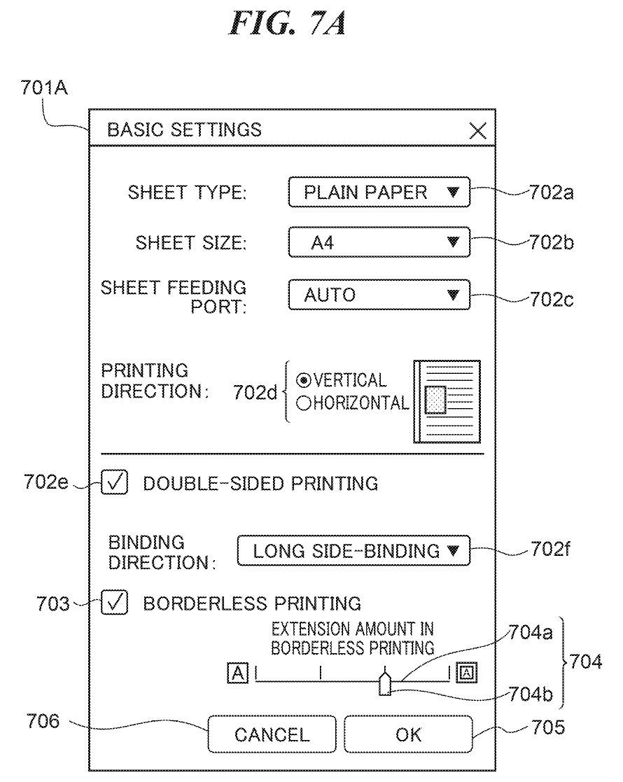

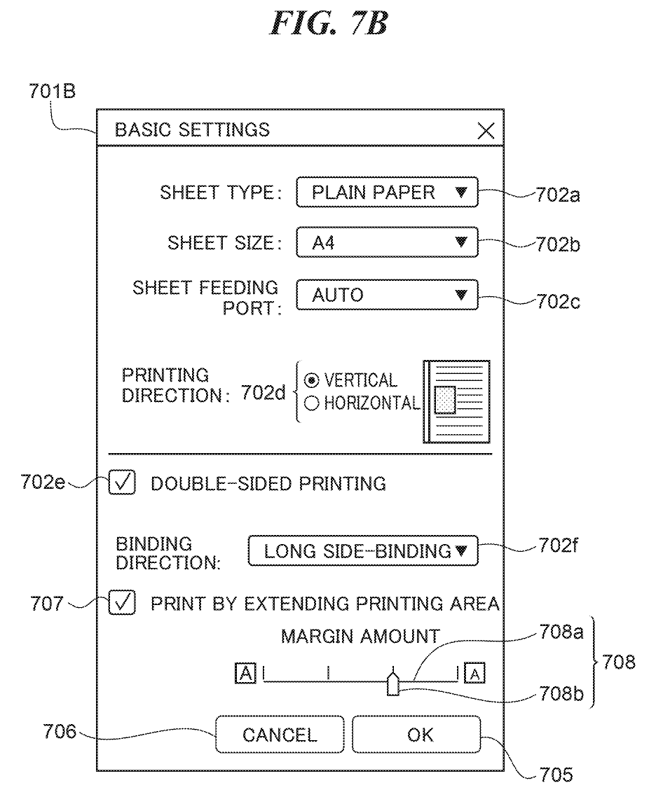

Referring to FIG. 2A, the configuration in the case where the extension application 204 is not associated with the print data generation software 202 and the printing apparatus 102 will be described first. A drawing application 201 is software for generating contents (print data) to be printed by the printing apparatus 102. The drawing application 201 is not particularly limited, but, for example, a document generation application, a spreadsheet application or the like can be the drawing application 201. The drawing application 201 issues a print instruction to the OS e.g. upon receipt of a print request from a user via the keyboard 118. The print instruction includes print setting information for instructing operations of the print data generation software 202 and the printing apparatus 102. The print setting information is also referred to as the Print Ticket (PT). Further, on the display section 119, the print settings screen 701A (see FIG. 7A) and the print settings screen 701B (see FIG. 7B) are displayed. The print settings screen 701A and the print settings screen 701B each include setting items indicating print functions which can be set according to capabilities information acquired by the print data generation software 202, i.e. information which can be set as the print settings, and control items indicating settings thereof. The capabilities information refers to information related to the capabilities of the printing apparatus 102 for performing printing, i.e. information including information which can be set by a user as the print settings when printing is performed by the printing apparatus 102 and is also referred to as the Print Capabilities (hereinafter sometimes referred to as the “PC”). Further, based on this capabilities information, it is also possible to determine whether or not edge information related to at least one of an extension amount and a margin amount, described hereinafter, has been acquired from the printing apparatus 102 (determination step). Then, as a result of this determination, if it is determined that the edge information has been acquired from the printing apparatus 102, the print settings screen 701A or the print settings screen 701B is displayed. On the other hand, if it is determined that the edge information has not been acquired from the printing apparatus 102, the display of the print settings screen 701A (and also, the print settings screen 701B) is inhibited. Thus, the extension application 204 can switch whether or not to display the print settings screen 701A (and also, the print settings screen 701B) according to the capabilities information of the printing apparatus 102.

The print data generation software 202 determines a PC based on print function information 203. The print function information 203 is data indicating all print functions which can be set, settings of these print functions, and a print function describing an exclusive relation between settings, and the like. The print function information 203 is also referred to as the Print Device Capabilities (PDC). The print function information 203 is included in a configuration file of the print data generation software 202 and is disposed in the external storage device 114. Alternatively, the print function information 203 is dynamically generated by the print data generation software 202. Specifically, the print data generation software 202 acquires attribute data of the printing apparatus 102 from the printing apparatus 102. The print data generation software 202 generates the print function information 203 according to attribute information in the attribute data. Note that in a case where the print function information 203 is dynamically generated as described above, the print function information 203 can be edited. Further, the attribute data of the printing apparatus 102 refers to a response acquired by issuing a Get-Printer-Attributes operation of the IPP to the printing apparatus 102. The response includes the attribute information (features) indicating the functions which can be designated in the printing apparatus 102, i.e. capabilities of the printing apparatus 102 and settings (options) associated with the attribute information. Further, the response is stored in the RAM 113.

With the configuration described above, the print data generation software 202 enables a user to designate a print function which can be used in the printing apparatus 102, according to the printing apparatus 102 connected to the print data generation software 202. With this, regardless of the printing apparatus 102 connected to the print data generation software 202, i.e. even in a case where the printing apparatus 102 having a different function or the printing apparatus 102 developed by a different printer maker is connected, it is possible to designate a print function which can be used in the connected printing apparatus 102. Note that in the present embodiment, it is assumed that the print data generation software 202 is configured to use the IPP Class Driver installed in Windows (registered trademark) 11. The IPP Class Driver is a printer driver that executes print processing according to specifications of a standard print protocol referred to as the IPP, and is incorporated in the OS package. The IPP Class Driver is not a printer driver specific to a model of the printing apparatus 102 but is a standard class driver which can be commonly used for printing apparatuses 102 of printer makers, without depending on a specific printer maker. Further, the IPP Class Driver acquires the capabilities information of the printing apparatus 102 and generates the print function information 203 based on the acquired information.

Further, the print data generation software 202 can be associated with the extension application 204. This enables the print data generation software 202 to execute a function which is not supported by the print data generation software 202. For example, the IPP Class Driver (the print data generation software 202) cannot execute a function of receiving a setting of a positional relationship between edges of a print sheet and an image forming area on the print sheet when printing is performed by an image forming apparatus which is capable of printing an image on a print sheet. This is because the function of receiving a positional relationship is a function uniquely executed by the printing apparatus 102 manufactured by a predetermined printer maker. The extension application 204 can extend the positional relationship-setting function which cannot be executed by the IPP Class Driver such that the positional relationship-setting function can be executed. Although in the present embodiment, the IPP Class Driver cannot execute the positional relationship-setting function, and the extension application 204 can extend the positional relationship-setting function such that the positional relationship-setting function can be executed, this is not limitative. For example, the IPP Class Driver can execute part of the positional relationship-setting function, and the extension application 204 can further extend the execution range by compensating for the shortage of the positional relationship-setting function.

The OS generates intermediate data (sometimes referred to as the input data) based on a print instruction output from the drawing application 201 and transmits the generated intermediate data to the print data generation software 202. The data to be output for printing from the drawing application 201 is not particularly limited, but, for example, data of the XML Paper Specification format (XPS format) is preferable. Further, as the data to be output for printing from the drawing application 201, data of the Graphic Device Interface format (GDI format) can be used. In a case where the IPP Class Driver is used as the print data generation software 202, if data output from the drawing application 201 is GDI data, the OS converts the GDI data to XPS data. Then, the OS transmits the converted XPS data to the print data generation software 202 as the intermediate data. Further, if data output from the drawing application 201 is XPS data, the OS transmits the XPS data to the print data generation software 202 as the intermediate data. Note that the intermediate data includes drawing data as information on characters, figures, and the like, which are to be formed on a print sheet (hereinafter sometimes referred to as the “sheet”), and the print setting information set by the user.

The print data generation software 202 converts the intermediate data to print data (image data) which can be processed, i.e. can be printed by the printing apparatus 102, and transmits the converted data to the printing apparatus 102. Here, the print data in the present embodiment is Page Description Language (PDL) data conforming to the IPP. The PDL data is, for example, data of the PDF (Portable Document Format) or of the PWG-Raster format. Note that the print data includes drawing data as information on e.g. characters, figures, and the like, which are to be formed on a print sheet (printing medium), and print setting attribute information designating print settings, which is generated based on the print setting information set by the user. The print setting attribute information includes attribute information (features) indicating functions which can be designated in the printing apparatus 102, i.e. the capabilities of the printing apparatus 102, and settings (options) associated with the attribute information.

The printing apparatus 102 performs printing on a print sheet based on the print data transmitted from the print data generation software 202. In doing this, the printing apparatus 102 can form an image on the print sheet based on the drawing data included in the print data, by performing operations according to the print setting attribute information included in the print data. Note that the print setting attribute information includes the attribute information for designating a print quality setting, such as image quality priority or speed priority, double-sided printing or single-side printing, and so forth, and settings of the attribute information. For example, in a case where attribute information designating double-sided printing is included in the print setting attribute information, the printing apparatus 102 can execute double-sided printing.

Referring to FIG. 2B, the configuration in the case where the extension application 204 is associated with the print data generation software 202 and the printing apparatus 102 will be described. As shown in FIG. 2B, differently from FIG. 2A, the extension application 204 is additionally provided. That is, the host computer 101 includes the drawing application 201, the print data generation software 202, and the print function information 203, and further has the extension application 204. The extension application 204 is software for extending the functions of the print data generation software 202. Note that the extension application 204 is software not included (packaged) in the OS in advance. Therefore, the extension application 204 is downloaded from a server (not shown) via the Internet and installed into the host computer 101 according to a user’s operation of the host computer 101. Alternatively, when the printing apparatus 102 is connected to the host computer 101, the extension application 204 can be automatically installed into the host computer 101 according to this connection. Specifically, in a case where the printing apparatus 102 is connected to the host computer 101, the OS acquires device identification information from the printing apparatus 102. The OS can download the extension application 204 associated with this device identification information from the server via the Internet and install the downloaded extension application 204. As a result, in the host computer 101, the print data generation software 202 and the extension application 204 are held as control programs different from each other. Note that the print data generation software 202 and the extension application 204 are sometimes updated and their versions are upgraded, respectively. The processing for updating the print data generation software 202 and the processing for updating the extension application 204 in this case are performed at the same timing or at different timings. Further, a trigger with which the print data generation software 202 is acquired by the host computer 101 and a trigger with which the extension application 204 is acquired by the host computer 101 can be the same trigger or the different triggers. Further, in a case where the extension application 204 has been installed, the OS associates the extension application 204 with the print data generation software 202 and the printing apparatus 102.

As shown in FIG. 2B, the extension application 204 is capable of exchanging information (transmission and reception of information) with the print data generation software 202 and the printing apparatus 102, respectively. That is, the extension application 204 is associated with the print data generation software 202 and the printing apparatus 102. In the present embodiment, the extension application 204 includes a print settings screen-extending unit 205, a skip control unit 206, a print function-extending unit 207, a print data-editing unit 208, a notification unit 209, and a capabilities information acquisition unit 211. Further, the extension application 204 includes shared information 210 which can be accessed from each of the print settings screen-extending unit 205, the print function-extending unit 207, the print data-editing unit 208, the notification unit 209, and the capabilities information acquisition unit 211. The shared information 210 is a file stored in the external storage device 114 or information stored in the RAM 113. The extension application 204 can write and read the shared information 210 by using an Application Program Interface (API) provided by the OS.

The shared information 210 includes positional relationship information on a positional relationship between edges of a print sheet and an image forming area on the print sheet, in which an image is formed by printing by an image forming apparatus which is capable of printing an image on a print sheet. The host computer 101 receives a position setting between the edges of the print sheet and the image forming area from a plurality of options based on this positional relationship information. That is, the host computer 101 can display the print settings screen 701A (and also, the print settings screen 701B) which receives the position setting at a plurality of levels on the display section 119 (display control step). Each option on the print settings screen 701A is set based on the edge information related to the extension amount. Each option on the print settings screen 701B is set based on the edge information related to the margin amount. The extension amount refers to an amount by which an image can extend off a top end, a bottom end, a left end, and a right end of a print sheet. By setting the extension amount, the borderless printing can be performed, but image missing is caused by an amount corresponding to the extension amount. The margin amount refers to an amount by which a margin can be formed between the top end, the bottom end, the left end, and the right end of the print sheet, and an image. By setting the margin amount, printing having a margin can be performed. In a case where, for example, -3.0 mm can be set as the extension amount , the image is printed such that the image extends outward off the top end, the bottom end, the left end, and the right end of the print sheet by 3.0 mm, respectively. In a case where, for example, 3.0 mm can be set as the margin amount, the image is printed in a state having a margin of 3.0 mm inward from the top end, the bottom end, the left end, and the right end of the print sheet, respectively.

Thus, the print settings screen 701A and the print settings screen 701B are set based on the edge information related to at least one of the extension amount and the margin amount, respectively. Further, the extension amount and the margin amount can be determined for each size of the print sheet, or commonly determined regardless of the size of the print sheet, or determined for each type of the printing apparatus 102. In a case where the positional relationship information has already been included in the print function information 203 acquired from the printing apparatus 102, the positional relationship information included in the print function information 203 can be directly used without using the positional relationship information included in the shared information 210.

Note that the extension application 204 can terminate the whole operation of the extension application 204 in accordance with termination of any of the above-described units. In this case, the OS starts the extension application 204 whenever a request for causing any of the above-described units to execute processing is received. For example, the OS terminates the whole operation of the extension application 204 in a case where processing executed e.g. by the print settings screen-extending unit 205 is terminated. Further, even when the processing executed by the skip control unit 206 is terminated, the OS can hold the other units in the activated state. Further, while the processing is being performed by each unit, the extension application 204 can cancel this processing. In this case, a job being processed on a print queue is deleted by the OS. As described above, upon receipt of a print request from a user, the drawing application 201 issues a print instruction to the OS. Further, the drawing application 201 can display the print settings screen. In the configuration shown in FIG. 2B, the drawing application 201 displays a print settings screen unique to the drawing application 201. After that, the drawing application 201 can display the print settings screen 701A or the print settings screen 701B provided by the print settings screen-extending unit 205 (the extension application 204). Further, the print settings screen-extending unit 205 can store detailed settings made by the user in the shared information 210.

Further, in a case where the drawing application 201 receives a print request and issues the corresponding print instruction to the OS, the OS starts the skip control unit 206. The skip control unit 206 controls whether or not to skip processing of the print data generation software 202. After the skip control processing is executed by the skip control unit 206, the OS generates intermediate data based on the print instruction output from the drawing application 201. This intermediate data is transmitted to the print data generation software 202. Note that in a case where the skip control processing is not executed by the skip control unit 206, the intermediate data is processed into print data which can be interpreted by the print data generation software 202 of the printing apparatus 102. This print data is transmitted to the print data-editing unit 208. Further, in a case where the processing by the print data generation software 202 is skipped, the intermediate data is transmitted to the print data-editing unit 208 without being processed by the print data generation software 202. With this, the intermediate data can be processed by the print data-editing unit 208. Examples of a case where it is preferable to skip the processing by the print data generation software 202 include a case where it is desired to perform enlargement/reduction processing by the print data-editing unit 208 based on the above-described positional relationship information. The intermediate data can be held in the vector format and is less deteriorated when enlarged or reduced. Therefore, in a case where the print data generation software 202 outputs the image in the raster format, it is preferable to skip the processing by the print data generation software 202 and process the intermediate data by the print data-editing unit 208.

The print data-editing unit 208 edits the intermediate data received from the print data generation software 202 or the print data processed by the print data generation software 202. For example, in a case where enlarged printing is performed, the print data-editing unit 208 changes enlargement/reduction of the intermediate data or the print data based on the print setting information of enlarged printing received from the OS. Further, the print data-editing unit 208 can display a result of laying out the intermediate data or the print data on the display section 119 as a preview screen. Note that the print data is not transmitted to the printing apparatus 102, in a state in which the print data-editing unit 208 is displaying a user interface screen (UI screen), such as the preview screen, on the display section 119. Further, by closing the UI screen, the print data can be transmitted. The print data is printed by the printing apparatus 102.

The print function-extending unit 207 can edit the print function information 203 (PDC) generated by the print data generation software 202 or the OS. This makes it possible to add a function provided by the extension application 204. Further, it is also possible to add a function which can be executed in the printing apparatus 102 but cannot be executed by the print data generation software 202 (such as the function of enlarging/reducing printing) and add an exclusive relationship between settings of the print function. The OS starts the print function-extending unit 207 when the extension application 204 is associated with the printing apparatus 102 and the print data generation software 202 for the first time. Further, the OS can start the print function-extending unit 207 at a timing other than this (e.g. at a timing when the OS is started). By starting the print function-extending unit 207 as described above, even in a case where a function related to printing is extended later, the print function-extending unit 207 can detect the extended function and add the detected function to the print function information 203. Examples of the case where the function related to printing is extended later include a case where an optional apparatus (such as a finisher) is added to the printing apparatus 102 afterwards.

The notification unit 209 can provide, when an error of the printing apparatus 102 occurs, a notification indicating this fact. For example, if a paper-out error has occurred in the printing apparatus 102, the print data generation software 202 detects occurrence of this error. The OS displays a message showing occurrence of the paper-out error as a result of the detection performed by the print data generation software 202 on the display section 119 by using a notification function called a toast notification which is one of the functions of the OS. Note that when the user operates the toast notification, the notification unit 209 is called by the OS, and a user interface screen (UI screen) of the notification unit 209 is displayed. On the user interface screen, for example, a detailed message concerning the paper-out error, a paper filling method, and so forth can be displayed. The capabilities information acquisition unit 211 acquires the capabilities information from the printing apparatus 102.

As described above, in the present embodiment, it can be said that the extension application 204 has the following six functions: The first function is the function of displaying a setting screen. This function is executed by the print settings screen-extending unit 205. The second function is the function of controlling whether or not to skip the processing by the print data generation software 202. This function is executed by the skip control unit 206. The third function is the function of editing print data input to the printing apparatus 102. This function is executed by the print data-editing unit 208. The fourth function is the function of extending a function which can be designated by using the print data generation software 202. This function is executed by the print function-extending unit 207. The fifth function is the function of displaying a screen in response to occurrence of an error in the printing apparatus 102. This function is executed by the notification unit 209. The sixth function is the function of acquiring the capabilities information from the printing apparatus 102. This function is executed by the capabilities information acquisition unit 211. Note that the configuration of the extension application 204 is not limited to the configuration having these six functions but preferably includes at least one function of them, and further, the extension application 204 can be configured to further have another function.

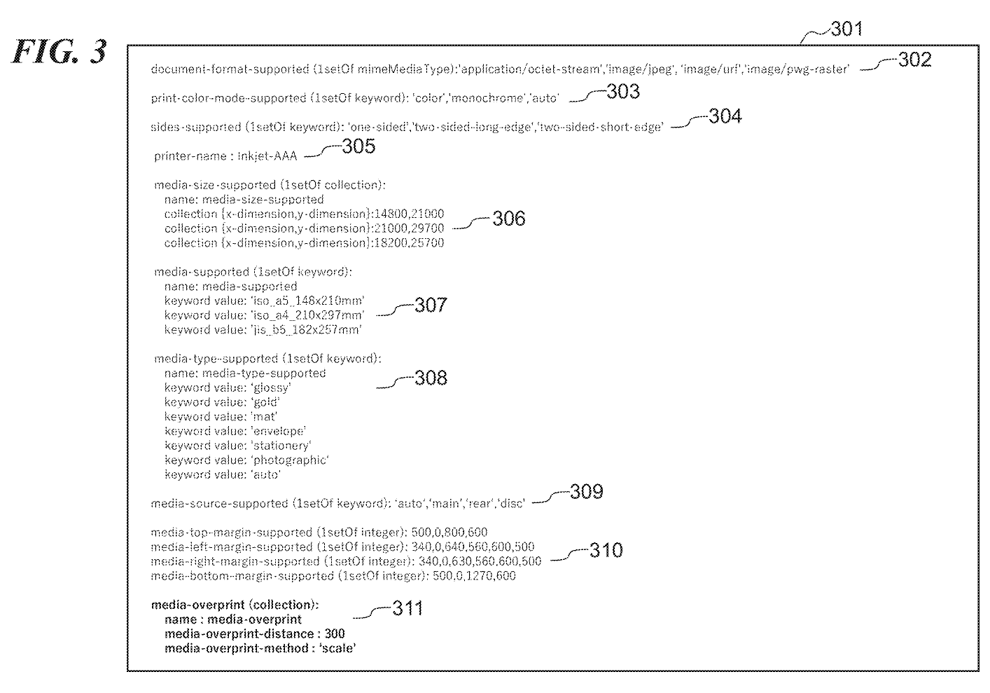

The print data generation software 202 acquires the capabilities information of the printing apparatus 102 from the printing apparatus 102. Then, the print data generation software 202 generates the print function information 203 based on the capabilities information. FIG. 3 is a diagram showing an example of a response acquired by the print data generation software 202 by issuing a Get-Printer-Attributes operation of the IPP to the printing apparatus. Information 301 shown in FIG. 3 includes the attribute information (features) indicating the functions which can be designated by the printing apparatus 102 as the IPP attributes and settings (options) associated with the attribute information. As shown in the information 301, the information of functions (features), such as a size and media, and settings (options) which can be set to each function are acquired from the printing apparatus 102.

Information 302 included in the information 301 is “document-format-supported”, which indicates print data formats which can be received, i.e. accepted by the printing apparatus 102. In FIG. 3, the information 302 indicates that the printing apparatus 102 supports the data formats of “application/octet-stream”, “image/jpeg”, “image/urf”, and “image/pwg-raster”. Information 303 included in the information 301 is “print-color-mode-supported", which indicates color modes which can be designated when printing is executed by the printing apparatus 102. In FIG. 3, the information 303 indicates that the printing apparatus 102 supports the color modes of “color”, “monochrome”, and “auto (auto selection)”. Information 304 included in the information 301 is” sides-supported”, which is information concerning double-sided printing performed by the printing apparatus 102. In FIG. 3, the information 304 indicates that the printing apparatus 102 supports double-sided printing of “Two-Sided-Short-Edge (short-side binding)” and “Two-Sided-Long-Edge (long-side binding)” with respect to the double-sided printing.

Information 305 included in the information 301 is “printer-name”, which is information concerning the name of the printing apparatus 102. In FIG. 3, the information 305 indicates that the name of the printing apparatus 102 is “Inkjet-AAA”. Information 306 included in the information 301 is “media-size-supported”, which is information concerning media size supported by the printing apparatus 102. In FIG. 3, the information 306 expresses a width and a height by information expressed in units of 1/100 mm and indicates that the printing apparatus 102 supports printing on sheets of sizes of A5, A4, and B5. Information 307 included in the information 301 is “media-supported”, which is information concerning the name of the media size supported by the printing apparatus 102. Information 308 included in the information 301 is “media-type-supported”, which is information concerning media types supported by the printing apparatus 102. In FIG. 3, the information 308 indicates that the printing apparatus 102 supports printing on the media types of “glossy (glossy standard)”, “gold (glossy gold)”, and “mat (mat photo paper)”. Further, the information 308 indicates that the printing apparatus 102 supports printing on the media types of “stationary (plain paper)”, “photographic (photo sheet)”, and “envelope (envelope sheet)”.

Information 309 included in the information 301 is “media-source-supported”, which is information concerning a sheet feeding method supported by the printing apparatus 102. In FIG. 3, the information 309 indicates that the printing apparatus 102 supports the sheet feeding methods of “auto (auto selection)”, “main (main tray)”, “rear (rear tray)”, and “disc (CD/DVD tray)”. Information 310 included in the information 301 is “media-top (bottom/left/right)-margin-supported”, which expresses a margin length, which can be set when printing is executed by the printing apparatus 102, by a length at the top, bottom, left, or right side of a print sheet. In FIG. 3, the information 310 indicates that a margin of 5 mm, 0 mm, 8 mm, or 6 mm can be set for the top side of the print sheet. Further, the information 310 indicates that a margin of 3.4 mm, 0 mm, 6.4 mm, 5.6 mm, 6 mm, or 5 mm can be set for the left side of the print sheet. Further, the information 310 indicates that a margin of 3.4 mm, 0 mm, 6.3 mm, 5.6 mm, 6 mm, or 5 mm can be set for the right side of the print sheet. Further, the information 310 indicates that a margin of 5 mm, 0 mm, 12.7 mm, or 6 mm can be set for the bottom side of the print sheet. Information 311 included in the information 301 is “media-overprint”, which is information concerning an extension amount in printing performed by the printing apparatus 102. In FIG. 3, the information 311 indicates that an image is printed by enlarging the image such that it can extend off the top, bottom, left, and right ends of the print sheet by 3 mm. Note that the information 301 to the information 311 are described by way of example and are not limited to the above-described information.

The print data generation software 202 generates the print function information 203 based on the information 301. FIG. 4 is a diagram showing an example of the print function information generated by the print data generation software. PDC 401 shown in FIG. 4 describes the print function information 203 in the xml format and includes the attribute information (features) indicating the functions which can be designated for the printing apparatus 102 and settings (options) associated with the attribute information. Information 402 included in the PDC 401 indicates a character string defined as a prefix of “name space” to which each feature or each option belongs, described in information 403, described hereinafter. The “name space” indicates a set or a range to which each feature or each option belongs. The name space is used to uniquely identify each feature or each option when the print data generation software 202, the OS, and the extension application 204 refer to the PDC or the PT/PC. For example, even when a feature or an option is defined by the same name, whether the feature or the option is defined by the OS standard or uniquely defined by a maker (vendor) can be expressed by the name space. Specifically, let it be assumed that “xmlns:psk = “http//schemas.com/printing/printschemakeywords”” is defined as the information 402. In this case, by adding psk as the prefix of each feature or each option, described in the information 403 after that, it is possible to define that the feature or the option belongs to the above-mentioned name space. In a case where the name space is defined by the OS standard, it is possible to express that the feature or the option belongs to the OS standard. Thus, the name space is used to uniquely identify a feature and an option.

The information 403 included in the PDC 401 indicates that ISOA4, ISOA5, and ISOB5 can be designated as “PageMediaSize (sheet size)”. In FIG. 4, “PageMediaSize” indicates a function (feature), and ISOA4 and the like indicate settings (options) associated with this function. The print function information 203 is generated based on the information 301. In the print function information 203, only the features and the options known to the OS are described. Therefore, the print function information 203 does not include the information indicating that the extension printing can be set, which is indicated by the information 311. Thus, in the print function information 203, only the standard or general-purpose features and options, out of the information acquired from the printing apparatus 102, are described.

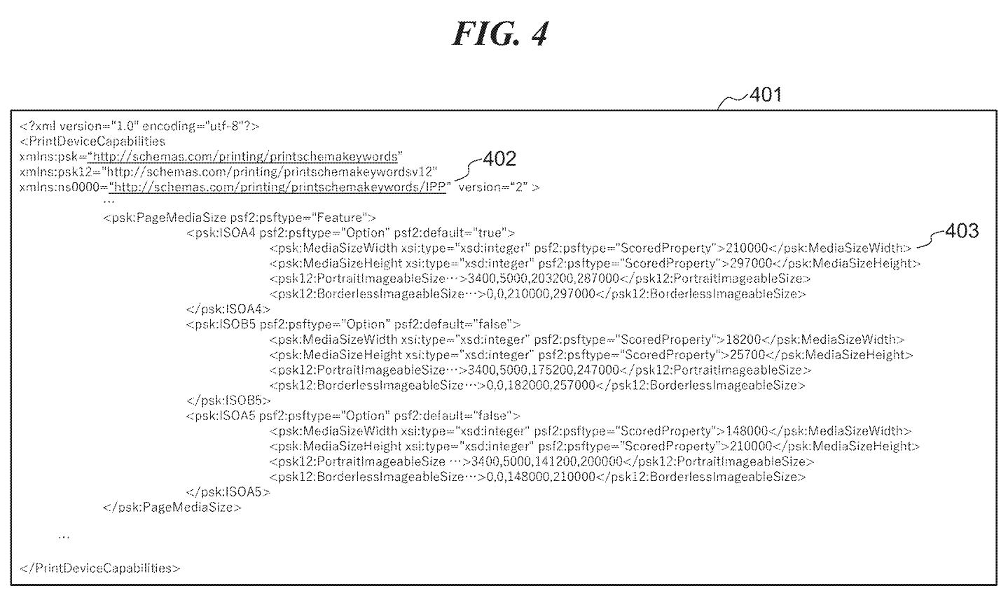

By editing the print function information 203, the print function-extending unit 207 can extend a function which can be used by a user when printing is performed by the printing apparatus 102 by using the print data generation software 202. Specifically, the print function-extending unit 207 describes new features and options in the print function information 203. With this, it is possible to add a function provided by the extension application 204 and a function which is supported by the printing apparatus 102 but is not supported by the print data generation software 202. FIG. 5 is a diagram showing an example of the print function information in which an extension amount-setting function is extended. In information 502 included in PDC 501 shown in FIG. 5, not only the information 402, but also “xmlns:ns0002 = “http://sample.com/printing/printschemakeywords/ v100” is defined. This is the prefix uniquely defined by the maker.

Information 503 included in the PDC 501 is the same as the information 403. Information 504 included in the PDC 501 indicates that four levels of “BorderlessExpandLevel” 1 to 4 can be designated as “BorderlessExpandValue (extension amount)”. Further, for BorderlessExpandLevel 1 to 4, the extension amount from each of the top end, the bottom end, the left end, and the right end of the print sheet is defined. In FIG. 5, the information 503 and the information 504 each express the extension amount in units of 1/1000 mm, and for example, 0, 0, 0, 0 are defined for “BorderlessExpandLevel 1”. In this case, the extension amounts from the top end, the bottom end, the left end, and the right end of the print sheet are set to 0 mm. Further, -3000, -3000, -3000, -3000 are defined for “BorderlessExpandLevel 4”. In this case, the extension amounts from the top end, the bottom end, the left end, and the right end of the print sheet are set to 3 mm. Note that although illustration is omitted, in a case where 3000, 3000, 3000, 3000 are defined, the respective margin amounts from the top end, the bottom end, the left end, and the right end of the print sheet are set to 3 mm. In the PDC 501, the extension amount and the margin amount can be determined for each size of the print sheet or commonly determined regardless of the size of the print sheet.

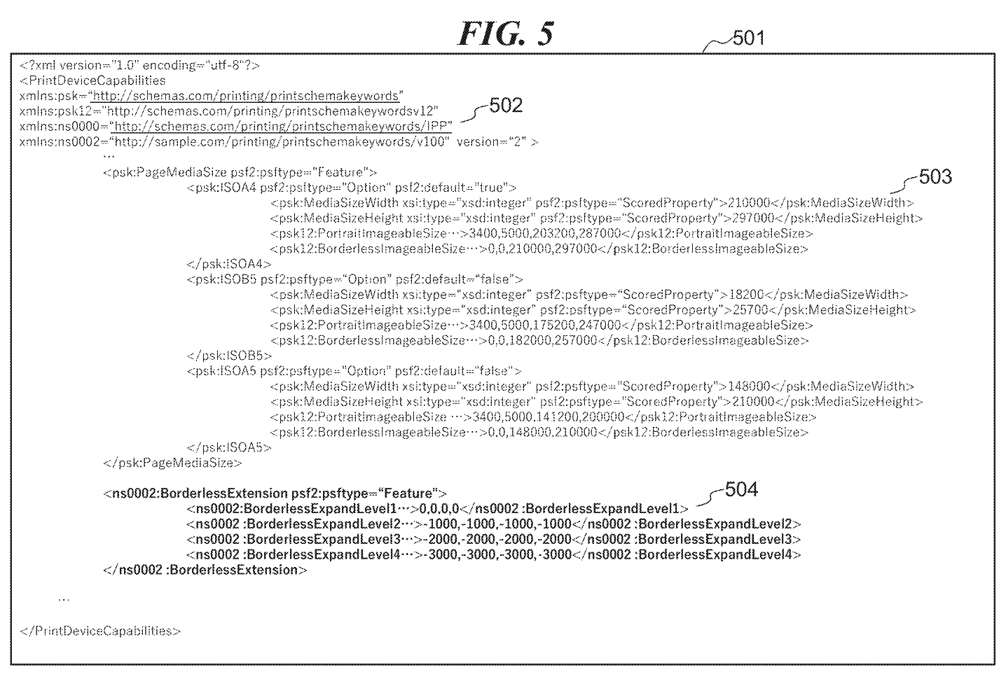

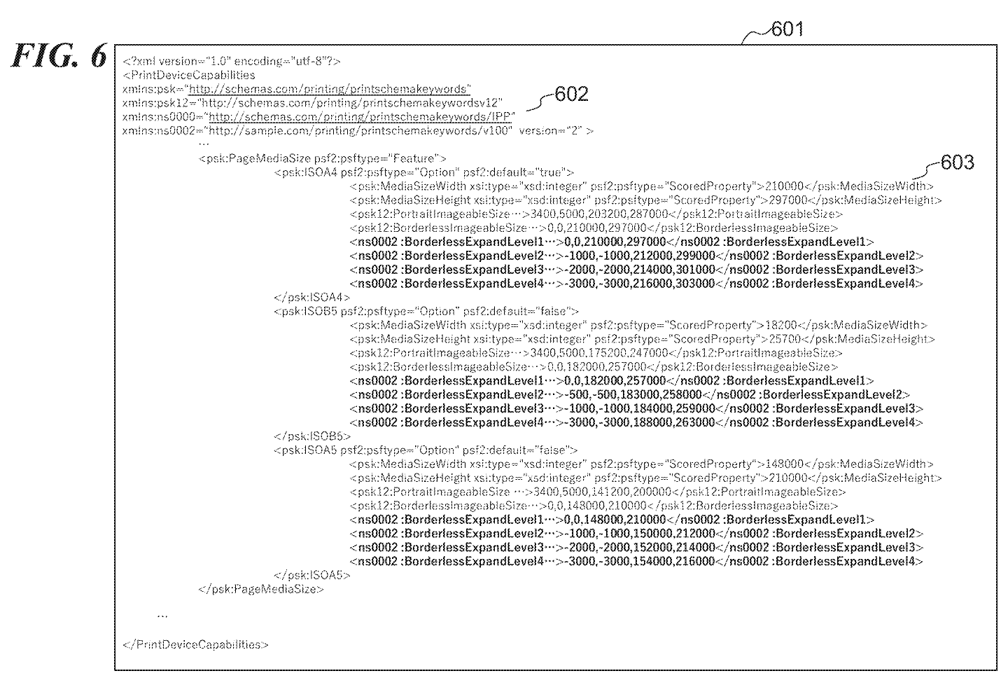

FIG. 6 is a diagram showing another example of the print function information in which the extension amount-setting function is extended. Information 602 included in PDC 601 shown in FIG. 6 is the same as the information 502. Information 603 included in PDC 601 defines an extension amount according to a size of the print sheet in addition to the information 503. In FIG. 6, -1000, -1000, 212000, 299000 are defined for “BorderlessExpandLevel 2” of ISOA4. In this case, a position extending off the origin at the upper left of the print sheet by each 1 mm in the longitudinal and horizontal directions becomes the origin to start printing. Further, printing is defined to be performed in an area having a width of 212.0 mm and a heigh of 299.0 mm. In this case, the extension amounts from the top end, the bottom end, the left end, and the right end are set to 1 mm with respect to the width of 210.0 mm and the height of 297.0 mm as the size of the print sheet of ISOA4. Further, -500, -500, 183000, 258000 are defined for the “BorderlessExpandLevel 2” of ISOB5. In this case, a position extending off the origin at the upper left of the print sheet each by 0.5 mm in the longitudinal and horizontal directions becomes an origin from which printing is started. Thus, it is possible to change the extension amount according to the size of the print sheet. Further, in a case where it is desired to disable the borderless printing for a specific size of the print sheet, the definition of the extension amount can be omitted for the print sheet size for which the borderless printing is desired to be disabled.

Further, not only the above-described addition of the function, but also, for example, deletion of an existing function and addition of an exclusive relation between settings of print functions (prohibition information) can be performed. A function to be added to the print function information 203 by the print function-extending unit 207 can be determined by using the information 301 acquired by the capabilities information acquisition unit 211 from the printing apparatus 102. The capabilities information acquisition unit 211 acquires the information 301 by issuing a Get-Printer-Attributes operation of the IPP to the printing apparatus 102. The print function-extending unit 207 can be configured to be capable of adding, out of the capabilities information acquired by the capabilities information acquisition unit 211, a feature and an option which do not exist in the existing print function information 203 to the print function information 203. Note that the method of adding a function to the print function information 203 is not limited to the above-described method. For example, a function to be added to the print function information 203 can be determined based on information stored in the shared information 210 in advance.

The print settings screen-extending unit 205 is called by the OS in a case where display of a print settings screen is instructed on the drawing application 201. FIGS. 7A and 7B are diagrams each showing an example of a print settings screen displayed on the display section 119 of the printing system 1000 by the print settings screen-extending unit. FIG. 7A shows the print settings screen on which an extension amount can be selected. FIG. 7B shows the print settings screen on which a margin amount can be selected. The print settings screen 701A shown in FIG. 7A and the print settings screen 701B shown in FIG. 7B are generated based on the PC (capabilities information), respectively. As shown in FIG. 7A, the print settings screen 701A includes controls 702a to 702f and controls 703 to 706.

With the control 702a, the user can select and set a type of a sheet used for printing performed by the printing apparatus 102. In FIG. 7A, “PLAIN PAPER” is selected by way of example. With the control 702b, the user can select and set a size of a sheet used for printing performed by the printing apparatus 102. In FIG. 7A, “A4” is selected by way of example. With the control 702c, the user can select and set a sheet feeding port of a sheet used for printing performed by the printing apparatus 102. In FIG. 7A, “AUTO” is selected by way of example. The control 702d is a checkbox for selecting a direction of printing performed by the printing apparatus 102. In FIG. 7A, “VERTICAL” of the control 702d is checked by way of example. In this case, the direction of printing performed by the printing apparatus 102 is set to the vertical direction. The control 702e is a checkbox for selecting whether or not to execute double-sided printing by the printing apparatus 102. In FIG. 7A, the control 702e is checked by way of example. In this case, the printing apparatus 102 is enabled to execute double-sided printing. With the control 702f, the user can select a binding direction of a printed matter output from the printing apparatus 102. In FIG. 7A, “LONG-SIDE BINDING” is selected by way of example.

The control 703 is a checkbox (selection section) for selecting whether or not to execute borderless printing by the printing apparatus 102, i.e., whether to enable or disable position setting between the edges of the print sheet and the image forming area. In FIG. 7A, the control 703 is checked by way of example. In this case, the printing apparatus 102 is enabled to execute borderless printing. Further, an operation on the control 704 is enabled when the control 703 is in a checked state. With the control 704, the user can select an extension amount as the position setting between the edges of the print sheet and the image forming area at a plurality of levels. Specifically, the control 704 is formed by a slider bar 704a and a slider 704b which can be moved on the slider bar 704a. Then, by moving the slider 704b, the user can select an extension amount of an image (image forming area) from each edge of the top end, the bottom end, the left end, and the right end of the print sheet at four levels (options). As the slider 704b is moved more leftward, the extension amount becomes smaller, whereas the slider 704b is moved more rightward, the extension amount becomes larger. In FIG. 7A, the slider 704b is adjusted to a position where the extension amount becomes the second largest by way of example. Note that the scale of the slider bar 704a is associated with “BorderlessExpandLevel 1 to 4” defined in the information 504. With the control 705, the user can store the settings made on the print settings screen 701A e.g. in the external storage device 114 and then close the print settings screen 701A. With the control 706, the user can close the print settings screen 701A without storing the settings made on the print settings screen 701A.

Next, the print settings screen 701B will be described, but the description will be given mainly of different points from the above-described print settings screen 701A, and description of the same points is omitted. As shown in FIG. 7B, similar to the print settings screen 701A, the print settings screen 701B includes the controls 702a to 702f and the controls 705 and 706. Further, the print settings screen 701B includes a control 707 and a control 708. The control 707 is a checkbox (selection section) for selecting whether or not to execute printing by extending a printing area in the printing apparatus 102, i.e., whether to validate or invalidate the setting of the margin amount. In FIG. 7B, the control 707 is checked by way of example. In this case, the printing apparatus 102 is enabled to execute printing by extending the printing area. Further, an operation on the control 708 is enabled when the control 707 is in a checked state. With the control 708, the user can select a margin amount as a position setting between the edges of the print sheet and the image forming area at a plurality of levels. Specifically, the control 708 is formed by a slider bar 708a and a slider 708b which can be moved on the slider bar 708a. Then, by moving the slider 708b, the user can select a margin amount of an image from each edge of the top end, the bottom end, the left end, and the right end of the print sheet at four levels. As the slider 708b is moved more leftward, the margin amount becomes smaller, whereas the slider 708b is moved more rightward, the margin amount becomes larger. In FIG. 7B, the slider 708b is adjusted to a position where the margin amount becomes the second largest by way of example. Note that the scale of the slider bar 708a is associated with “BorderlessExpandLevel 1 to 4” defined in the information 504.

The print settings screen-extending unit 205 determines whether to display the print settings screen 701A or the print settings screen 701B according to a type of the printing apparatus 102. For example, in a case where the printing apparatus 102 is an inkjet-type printing apparatus, the borderless printing can be performed. In this case, the print settings screen-extending unit 205 determines to display the print settings screen 701A. With the print settings screen 701A, it is possible to adjust the extension amount such that skew or the like occurring when a print sheet is conveyed in a case where the inkjet type printing apparatus is used is reduced as much as possible, and at the same time image missing caused by extension of an image is reduced. Further, in a case where the printing apparatus 102 is an electrophotographic printing apparatus, printing can be performed by extending the printing area. In this case, the print settings screen-extending unit 205 determines to display the print settings screen 701B. With the print settings screen 701B, it is possible to adjust, according to a size and a type of a print sheet used in the electrophotographic method, the margin amount to an amount recommended when printing is performed on the print sheet and the print sheet is conveyed.

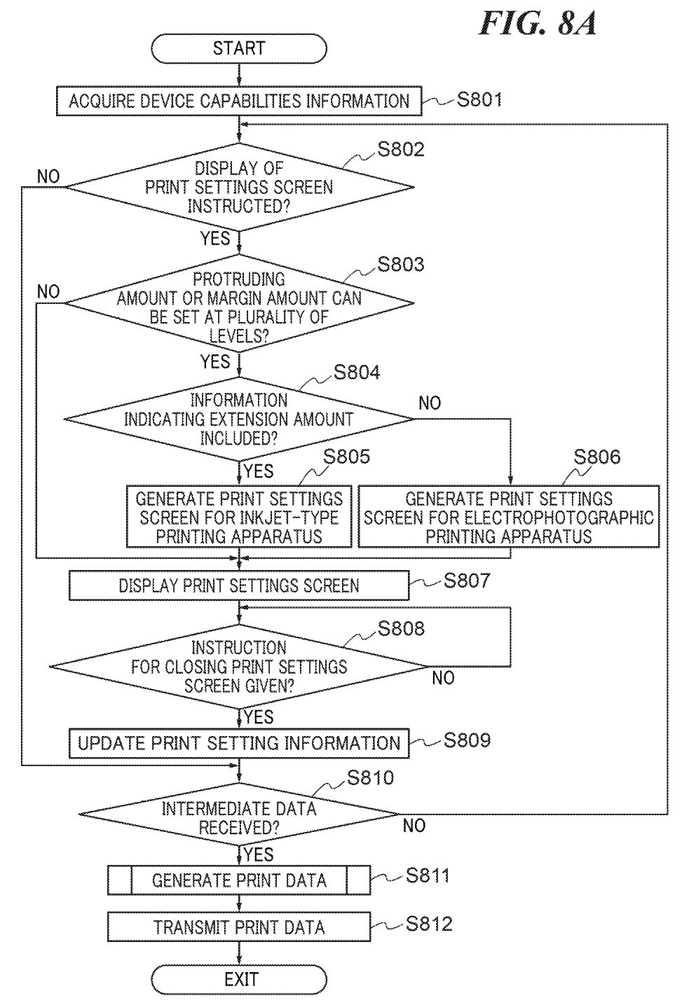

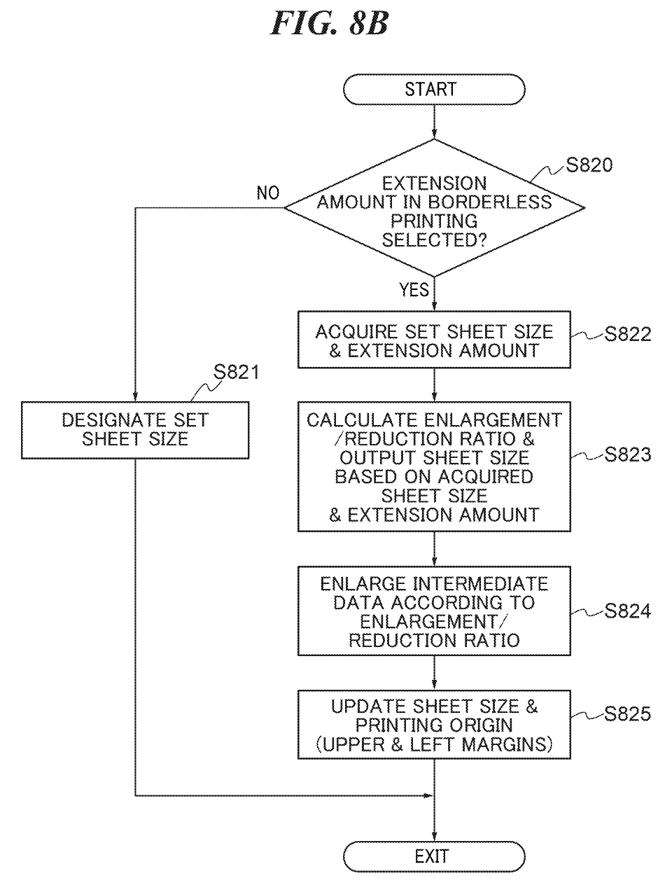

FIGS. 8A and 8B are flowcharts of processes executed by the extension application. FIG. 8A is a flowchart of a process executed by the print function-extending unit and so forth of the extension application. FIG. 8B is a flowchart of a process executed in a step S811 as a subroutine of the process in FIG. 8A. A program based on the process in FIG. 8A is executed when the extension application 204 starts the print function-extending unit 207. Referring to FIG. 8A, in a step S801, the capabilities information acquisition unit 211 (extension application 204) acquires the capabilities information, i.e., the information 301 (see FIG. 3) from the printing apparatus 102. The PDC 501 is generated based on this information 301. After execution of the step S801, the process proceeds to a step S802.

In the step S802, the print function-extending unit 207 (extension application 204) determines whether or not the display of the print settings screen 701A or the print settings screen 701B has been instructed by a user’s operation. If it is determined in the step S802 that the display of the print settings screen has been instructed, the process proceeds to a step S803. On the other hand, if it is determined in the step S802 that the display of the print settings screen has not been instructed, the process proceeds to a step S810.

In the step S803, the print function-extending unit 207 determines whether or not information which enables selection (setting) of the extension amount or the margin amount at a plurality of levels is included in the PDC 501 generated in the step S801. If it is determined in the step S803 that the information which enables selection of the extension amount or the margin amount at a plurality of levels is included, the process proceeds to a step S804. On the other hand, if it is determined in the step S803 that the information which enables selection of the extension amount or the margin amount at a plurality of levels is not included, the process proceeds to a step S807.

In the step S804, the print function-extending unit 207 determines whether or not information which enables selection of the extension amount at a plurality of levels, i.e. information indicating the extension amount is included in the PDC 501. This determination is performed based on whether or not a value indicating the extension amount is a minus value. In a case where the value indicating the extension amount is a minus value, it is determined that the information indicating the extension amount is included, whereas in a case where the value indicating the extension amount is not a minus value, it is determined that the information indicating the extension amount is not included. Then, if it is determined in the step S804 that the information indicating the extension amount is included, the process proceeds to a step S805. On the other hand, if it is determined in the step S804 that the information indicating the extension amount is not included, the process proceeds to a step S806.

In the step S805, the print settings screen-extending unit 205 (extension application 204) generates the print settings screen 701A suitable for the inkjet-type printing apparatus 102, on which the extension amount can be set, and the process proceeds to the step S807.

In the step S806, the print settings screen-extending unit 205 generates the print settings screen 701B suitable for the electrophotographic printing apparatus 102, on which the margin amount can be set, and the process proceeds to the step S807.

In the step S807 after execution of the step S805, the print function-extending unit 207 displays the print settings screen 701A generated in the step S805, and the process proceeds to a step S808. Further, in the step S807 after execution of the step S806, the print function-extending unit 207 displays the print settings screen 701B generated in the step S806, and the process proceeds to the step S808. Further, in the step S807 after execution of the step S803, the print function-extending unit 207 displays a print settings screen (not shown) different from the print settings screen 701A and the print settings screen 701B, and the process proceeds to the step S808. This print settings screen is an image which includes the controls 702a to 702f, the control 705, and the control 706, and from which the controls 703, 704, 707, and 708 are omitted.

In the step S808, the print function-extending unit 207 determines whether or not the control 705 on the print settings screen 701A or the print settings screen 701B, displayed in the step S807, has been operated. If it is determined in the step S808 that the control 705 has been operated, the process proceeds to a step S809. On the other hand, if it is determined in the step S804 that the control 705 has not been operated, the process remains in the step S808.

In the step S809, the print function-extending unit 207 updates the print setting information held at present to the print setting information set on the print settings screen 701A or the print settings screen 701B, and the process proceeds to the step S810.

In the step S810, the print data-editing unit 208 (extension application 204) determines whether or not the intermediate data has been received from the OS. If it is determined in the step S810 that the intermediate data has been received, the process proceeds to the step S811. On the other hand, if it is determined in the step S810 that the intermediate data has not been received, the process returns to the step S802 to sequentially execute the step S802 et seq.

In the step S811, the print data-editing unit 208 generates print data (resized image) by enlarging or reducing the intermediate data (image) based on the setting contents (options) received on the print settings screen 701A or the print settings screen 701B (generation step).

In a step S812, the print function-extending unit 207 transmits the print data generated in the step S811 to the printing apparatus 102 (transmission step), followed by terminating the process.

Next, the process executed in the step S811 of the process in FIG. 8A will be described with reference to FIG. 8B. Here, out of the extension amount and the margin amount, the description will be given focusing on the extension amount as a representative. Referring to FIG. 8B, in a step S820, the print data-editing unit 208 determines whether or not the control 703 on the print settings screen 701A is checked, i.e., whether or not the position setting between the edges of the print sheet and the image forming area is enabled. If it is determined in the step S820 that the control 703 is checked, the process proceeds to a step S822. On the other hand, if it is determined in the step S820 that the control 703 is not checked, the process proceeds to a step S821.

In the step S821, the print data-editing unit 208 acquires information concerning a sheet size, set on the control 702b on the print settings screen 701A, and designates this information as the sheet size to be transmitted to the printing apparatus 102, followed by terminating the process.

In the step S822, the print data-editing unit 208 acquires information concerning the sheet size, set on the control 702b on the print settings screen 701A, and information concerning an extension amount, set on the control 704, and the process proceeds to a step S823.

In the step S823, the print data-editing unit 208 calculates an enlargement/reduction ratio of the image and an output sheet size based on the information acquired in the step S822, and the process proceeds to a step S824. When calculating the enlargement/reduction ratio of the image and the output sheet size, first, a width and a height of the sheet, corresponding to the sheet size set on the control 702b, and the extension amount corresponding to the extension amount set on the control 704 are acquired from the information 503 and the information 504. For example, in a case where the sheet size “A4” is set on the control 702b, and the extension amount is set to the largest value on the control 704, the image extends off the top end, the bottom end, the left end, and the right end of the print sheet by “3 mm” as the extension amount defined for “BorderlessExpandLevel4”. As the sheet size, the width of the sheet is obtained by “210.0 mm - (-3 mm) - (-3 mm) = 216.0 mm”, and the height of the sheet is obtained by “297.0 mm - (-3 mm) - (-3 mm) = 303.0 mm”. Then, the enlargement/reduction ratio is obtained by “216.0 ÷ 210.0 × 100 = 102.9%” in the width direction, and “303.0 ÷ 297.0 × 100 = 102.0%” in the height direction. Therefore, to enlarge the image to extend off the top end, the bottom end, the left end, and the right end of the print sheet by “3 mm”, by comparing the enlargement/reduction ratios of the width and the height, “102.9%” which is the larger value of these becomes the enlargement/reduction ratio.

In the step S824, the print data-editing unit 208 enlarges the intermediate data at the enlargement/reduction ratio calculated in the step S823, and the process proceeds to a step S825.

In the step S825, the print data-editing unit 208 updates the information on the sheet size and the printing origin (defined by the upper margin and the left margin) to be transmitted to the printing apparatus 102, followed by terminating the process. The sheet size to be transmitted to the printing apparatus 102 is a sheet width of 216.0 mm x a sheet height of 303.0 mm, which is an output sheet size calculated in the step S823, i.e. a printing area in which printing can be performed by the printing apparatus 102. The printing origin is information for determining the position of the image arranged with respect to a sheet on which printing is performed by the printing apparatus 102. In a case where the margin is a minus value, the printing apparatus 102 disposes the image in a position extending off the sheet, whereas in a case where the margin is a plus value, the printing apparatus 102 disposes the image in such a position that margins are formed from the edges of the sheet. Therefore, in a case where the image is printed such that the image extends off the top end, the bottom end, the left end, and the right end of the print sheet by “3 mm”, the upper margin and the left margin which define the printing origin are both updated to the information of “-3 mm”. A variety of data thus acquired is transmitted in the step S812. This enables the printing apparatus 102 to print the image enlarged such that the image extends off the sheet.

As described above, in the printing system 1000, even in a case where the print data generation software 202 does not support the position setting between the edges of a print sheet and the image forming area, the extension application 204 can display the print settings screen 701A. Then, with this print settings screen 701A, it is possible to perform the position setting between the edges of a print sheet and the image forming area. This enables the printing apparatus 102 to execute printing according to the print setting. Further, although in the present embodiment, the upper margin and the left margin are designated to define the printing origin, this is not limitative, but it is only required to determine the position of the image arranged with respect to a sheet on which printing is to be performed by the printing apparatus 102. For example, the lower margin and the right margin can be designated to set the printing origin. Further, instead of designating the printing origin, the setting of the extension amount can be determined by the printing apparatus 102 based on the output sheet size and the information on the size of the sheet set on the printing apparatus 102. In this case, it is possible to determine the position of the image arranged with respect to the sheet, on which printing is to be performed, by calculating the extension amount from each of the top end, the bottom end, the left end, and the right end of the print sheet.

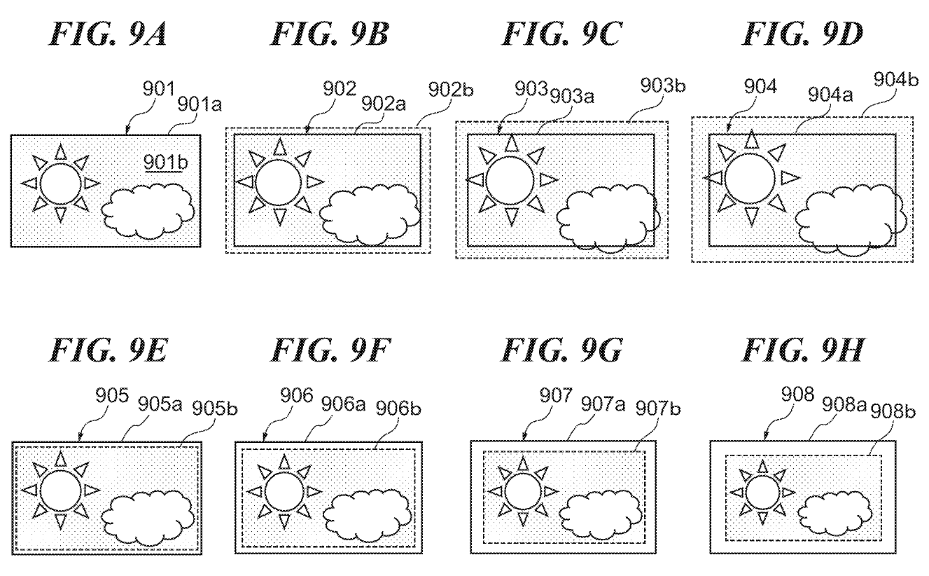

FIGS. 9A to 9H are diagrams each showing a print result obtained according to a setting of an extension amount or a margin amount. FIGS. 9A to 9D are diagrams showing print results obtained when the extension amount is set at the four levels, respectively. FIGS. 9E to 9H are diagrams showing print results obtained when the margin amount is set at the four levels, respectively. A printed matter 901 shown in FIG. 9A is a printed matter obtained in a case where the extension amount is the smallest, i.e. the size of a print sheet 901a and the size of an image forming area 902b coincide with each other. A printed matter 902 shown in FIG. 9B is a printed matter obtained in a case where the extension amount is the second smallest. In the printed matter 902, an image forming area 902b extends off a print sheet 902a. A printed matter 903 shown in FIG. 9C is a printed matter obtained in a case where the extension amount is the second largest. In the printed matter 903, an image forming area 903b extends off a print sheet 903a, and its extension amount is larger than that in the printed matter 902. A printed matter 904 shown in FIG. 9D is a printed matter obtained in a case where the extension amount is the largest. In the printed matter 904, an image forming area 904b extends off a print sheet 904a, and its extension amount is larger than the that in the printed matter 903.

A printed matter 905 shown in FIG. 9E is a printed matter obtained in a case where the margin amount is the smallest. In the printed matter 905, an image forming area 905b is slightly smaller than a print sheet 905a. A printed matter 906 shown in FIG. 9F is a printed matter obtained in a case where the margin amount is the second smallest. In the printed matter 906, an image forming area 906b is smaller than a print sheet 906a, and its margin amount is larger than the that in the printed matter 905. A printed matter 907 shown in FIG. 9G is a printed matter obtained in a case where the margin amount is the second largest. In the printed matter 907, an image forming area 907b is smaller than a print sheet 907a, and its margin amount is larger than that in the printed matter 906. A printed matter 908 shown in FIG. 9H is a printed matter obtained in a case where the margin amount is the largest. In the printed matter 908, an image forming area 908b is smaller than a print sheet 908a, and its margin amount is larger than that in the printed matter 907. In the electrophotographic method, if toner is applied up to an edge of a print sheet, there is a fear that the print sheet is difficult to separate from a belt for conveying a print sheet. For this reason, this difficulty in separation is prevented by providing a margin when printing is performed. On the other hand, in the inkjet method, it is possible to omit a margin, i.e., it is possible to perform the borderless printing.

Note that, to set an extension amount to a large amount, pixel data around the original image data can be expanded. In this case, since the pixel data around the original image data is expanded only in the surrounding area, it is possible to print the image data in the same size as the original image data. Further, since the image is not enlarged, it is possible to prevent image missing in the surrounding area. Further, in a case where the margin amount is set, the pixel data around the original image data can be changed to margin data. In this case, it is possible to print the image data in the same size as the original image data. Further, switching whether to enlarge the image data or expand the pixel data around the image data, when setting the extension amount, can be determined based on the capabilities information of the printing apparatus 102 or can be performed by operating a control for the switching provided on the print settings screen. The capabilities information of the printing apparatus 102 is defined by “media-overprint-method” indicated by the information 311. Further, switching whether to reduce the image data or change the pixel data around the image data to margin data, can be determined when the margin amount is set, can also be determined based on the capabilities information of the printing apparatus 102 or can be determined by operating a control for the switching arranged on the print settings screen.

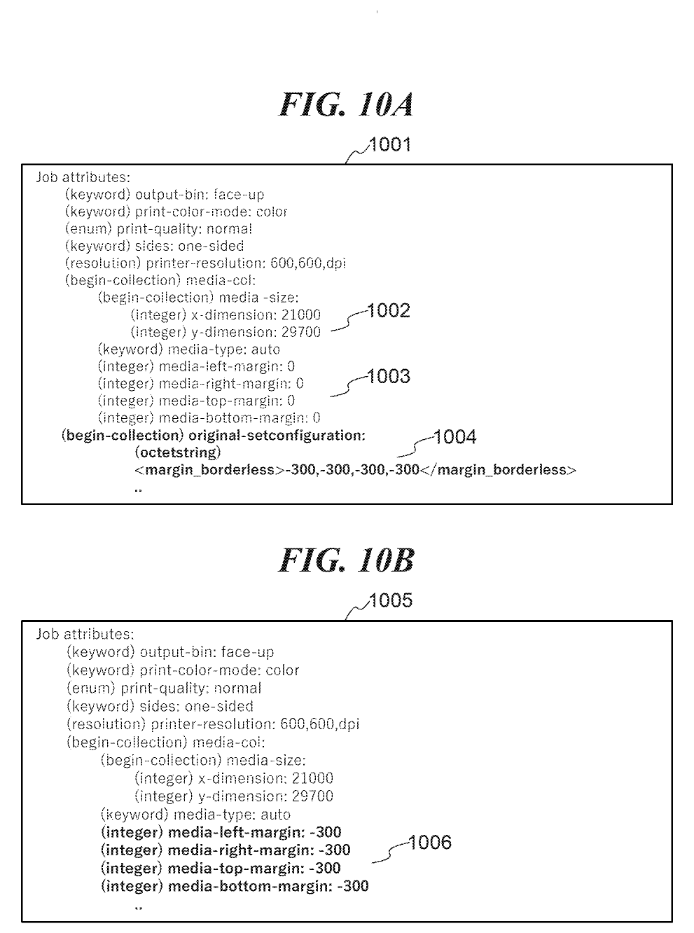

A second embodiment will be described below with reference to FIGS. 10A and 10B, but the description will be given mainly of different points from the above-described embodiment, and description of the same points is omitted. In the above-described first embodiment, the extension application 204 enlarges or reduces the intermediate data according to the setting of the extension amount. Then, this enlarged or reduced intermediate data is transmitted to the printing apparatus 102 and printed by the printing apparatus 102. In the present embodiment, the information related to settings of the borderless printing setting, received on the print settings screen 701A, is transmitted to the printing apparatus 102 (transmission step). In the printing apparatus 102, the image is enlarged or reduced and printed based on this information related to the settings of the borderless printing. In this case, the steps S823 to S825 are omitted from the process in FIG. 8B.

FIGS. 10A and 10B are diagrams each showing an example of print data transmitted from the extension application 204 according to the second embodiment to the printing apparatus 102. Print setting information 1001 shown in FIG. 10A is the print setting information generated by updating the information on the extension amount of the print data, which is acquired in the step S822 of the process in FIG. 8B. Information 1002 included in the print setting information 1001 indicates the A4 size selected by the control 702b on the print settings screen 701A as the size of the sheet printed by the printing apparatus 102. Information 1003 included in the print setting information 1001 indicates information on the top, bottom, left, and right margins. In FIG. 10A, the margins are set to “0 mm” by way of example. Information 1004 included in the print setting information 1001 expresses the extension amount from each of the top end, the bottom end, the left end, and the right end of the print sheet when printing is performed by the printing apparatus 102 by using a print setting command unique to the maker. In FIG. 10A, “-300”, “-300”, “-300”, and “-300” are described, by way of example, and this indicates that the extension amount from each of the top end, the bottom end, the left end, and the right end of the print sheet is set to “3 mm”.

The extension application 204 transmits the print data including the print setting information 1001 to the printing apparatus 102 in the step S812. In a case where this print data is received, the printing apparatus 102 calculates the enlargement/reduction ratio based on the information 1002 and the information 1004. The printing apparatus 102 executes processing for enlarging or reducing the image data included in the print data based on the calculated enlargement/reduction ratio. Then, the printing apparatus 102 executes printing of the enlarged/reduced image data by setting the position designated in the information 1004 as the printing origin.

Print setting information 1005 shown in FIG. 10B is also the print setting information generated by updating the information on the extension amount of the print data, which is acquired in the step S822 of the process in FIG. 8B. Information 1006 included in the print setting information 1005 indicates that the extension amount from each of the top end, the bottom end, the left end, and the right end of the print sheet is set to “3 mm” as the top, bottom, right, and left margins, based on the extension amount set on the control 704 on the print settings screen 701A and the information 504.

As described above, in the present embodiment, enlargement/reduction of image data is performed by the printing apparatus 102. With this, even in a case where it is difficult to perform enlargement/reduction of intermediate data by the extension application 204, it is possible to adjust the extension amount and instruct the borderless printing from the extension application 204.

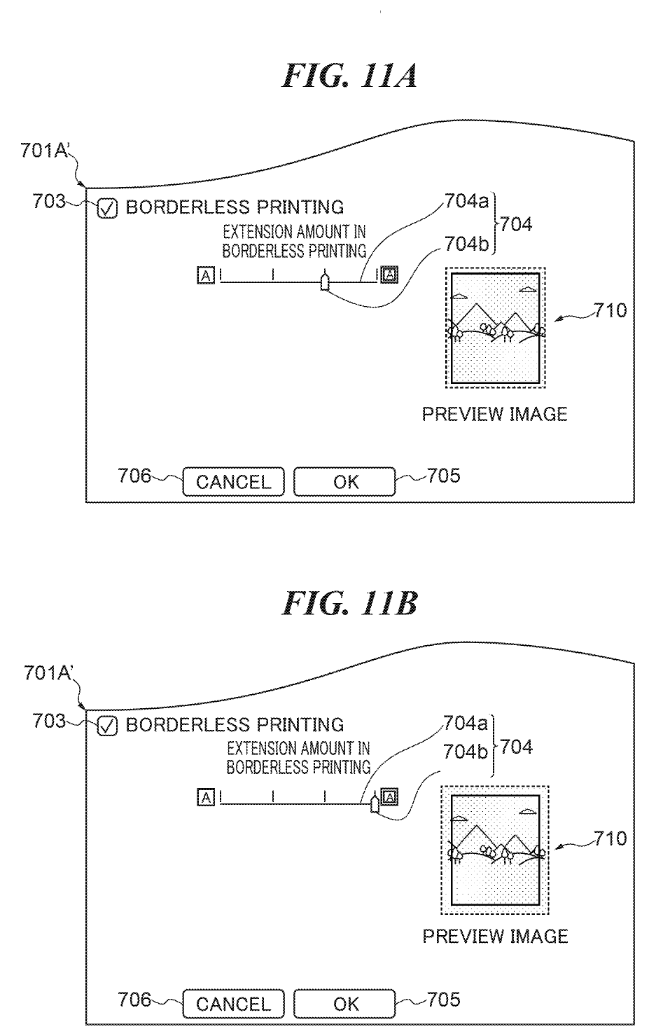

A third embodiment will be described below with reference to FIGS. 11A and 11B, but the description will be given mainly of different points from the above-described embodiments, and description of the same points is omitted. FIGS. 11A and 11B are diagrams each showing an example of a print settings screen displayed on the display section 119 of the printing system 1000 by the print settings screen-extending unit according to the third embodiment. FIG. 11A is a diagram showing a state in which the extension amount is set to the second largest amount. FIG. 11B is a diagram showing a state in which the extension amount is set to the largest amount. As shown in FIGS. 11A and 11B, on a print settings screen 701A’, based on a setting received by the control 704 on the print settings screen 701A’, a preview image 710 is displayed which is a resized image obtained by enlarging or reducing an image to be printed. Further, on the print settings screen 701A’, the extension amount in the preview image 710 is changed in conjunction with an operation of the slider 704b of the control 704. This makes it possible to grasp the extension amount.

According to the present disclosure, even in a case where a standard driver is used, it is possible to perform position setting on a positional relationship between the edges of a printing medium and an image forming area in which an image is formed on the printing medium.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-041420, filed March 14, 2025, which is hereby incorporated by reference herein in its entirety.

What is claimed is:

1. A non-transitory computer-readable storage medium storing an application program supporting a standard driver that is provided from a provider of an operating system, the application program causing a computer to execute a control method comprising:
displaying, when printing is performed by an image forming apparatus capable of printing an image on a printing medium, a reception screen for receiving a position setting on a positional relationship between edges of the printing medium and an image forming area in which the image is formed by the printing on the printing medium, from a plurality of options.

2. The non-transitory computer-readable storage medium according to claim 1, wherein each of the options is set based on edge information related to at least one of an extension amount by which the image can extend off the edges of the printing medium and a margin amount which can be formed between the edges of the printing medium and the image.

3. The non-transitory computer-readable storage medium according to claim 2, wherein the control method further comprises determining whether or not the edge information has been acquired from the image forming apparatus before the displaying, and
wherein the displaying includes displaying the reception screen in a case where, as a result of the determining, it is determined that the edge information has been acquired from the image forming apparatus, and inhibiting the display of the reception screen in a case where the edge information has not been acquired from the image forming apparatus.

4. The non-transitory computer-readable storage medium according to claim 1, wherein the displaying includes displaying a slider bar and a slider which can be moved on the slider bar as one of the options.

5. The non-transitory computer-readable storage medium according to claim 1, wherein the displaying can display a preview image of a resized image obtained by enlarging or reducing the image based on the option received on the reception screen.

6. The non-transitory computer-readable storage medium according to claim 1, wherein the reception screen includes a selection section for selecting whether to enable or disable the position setting.

7. The non-transitory computer-readable storage medium according to claim 1, wherein the control method further comprises generating a resized image by enlarging or reducing the image based on the option received on the reception screen, and
transmitting the resized image generated by the generating to the image forming apparatus.

8. The non-transitory computer-readable storage medium according to claim 1, wherein the control method further comprises transmitting information on the option received on the reception screen to the image forming apparatus.

9. The non-transitory computer-readable storage medium according to claim 1, wherein the function of setting the position setting is a function which cannot be executed by the standard driver.

10. A control method of performing control to support a standard driver that is provided from a provider of an operating system, comprising:
displaying, when printing is performed by an image forming apparatus capable of printing an image on a printing medium, a reception screen for receiving a position setting on a positional relationship between edges of the printing medium and an image forming area in which the image is formed by the printing on the printing medium, from a plurality of options.

11. An information processing apparatus including a standard driver that is provided from a provider of an operating system and an application program supporting the standard driver,
the application program causing a computer of the information processing apparatus to execute a control method comprising:
displaying, when printing is performed by an image forming apparatus capable of printing an image on a printing medium, a reception screen for receiving a position setting on a positional relationship between edges of the printing medium and an image forming area in which the image is formed by the printing on the printing medium, from a plurality of options.
